(19) United States
(12) Patent Application Publication
(10) Pub. No.: US 2025/0335265 A1
(43) Pub. Date: Oct. 30, 2025

(54) USING PLUGIN VOTING TO DETERMINE A PLACEMENT LOCATION TO EXECUTE A COMPUTER WORKLOAD

(71) Applicant: RED HAT, INC., Raleigh, NC (US)

(72) Inventor: William Caban Babilonia, Annapolis, MD (US)

(21) Appl. No.: 18/644,256

(22) Filed: Apr. 24, 2024

(51) Int. Cl. G06F 9/50

(52) U.S. Cl. CPC G06F 9/5083; G06F 9/5033; G06F 9/5038

(57) ABSTRACT

A placement service can be used to determine workload placement using plugin voting. The placement service can transmit a voting request to one or more plugins to request input from the one or more plugins to determine a placement location to assign a workload. The voting request can indicate a predefined time limit by which to respond to the voting request. The placement service can receive a set of responses. Each response can be generated by a respective plugin and indicate at least one respective candidate location to execute the workload. The placement service can determine the placement location based on the set of responses received from the one or more plugins. Subsequent to determining the placement location, the placement service can assign the workload to the placement location for execution.

### TECHNICAL FIELD

The present disclosure relates generally to determining a suitable location in a computing environment to execute a computer program or application. More specifically, but not by way of limitation, this disclosure relates to using plugin voting to determine a placement location in a computing environment to execute a computer workload.

### BACKGROUND

A distributed computing system may execute one or more workloads, such as to run applications, on local computing environments and cloud-based computing environments. The distributed computing system can use a scheduler to manage a flow of the workloads to different locations in the distributed computing system, such as based on resource requirements associated with the workloads. The scheduler can determine a location at which to execute a workload of the distributed computing system. Once the scheduler determines the location, the scheduler can assign the workload to be executed at the location.

### BRIEF DESCRIPTION OF THE DRAWINGS

FIG. 1 is a block diagram of an example of a computing environment for determining workload placement using plugin voting according to some examples of the present disclosure.

FIG. 2 is a block diagram of example responses received by a placement service to determine workload placement using plugin voting according to some examples of the present disclosure.

FIG. 3 is a block diagram of an example of a computing device for determining workload placement using plugin voting according to some examples of the present disclosure.

FIG. 4 is a flowchart of a process for determining workload placement using plugin voting according to some examples of the present disclosure.

### DETAILED DESCRIPTION

Hybrid computing environments in which workloads are run in different environments are becoming increasingly common. These hybrid computing environments can be mixed computing environments that include on-premises data centers and cloud computing environments, such as public clouds and private clouds. A placement service can be used to manage workload placement by applying a series of filters and weights to available deployment targets to narrow down a set of candidate locations to assign a workload in a computing environment. In particular, the placement service may first apply a set of filters to generate a filtered subset of the available deployment targets and then apply a set of weights to the filtered subset to generate a weighted subset as the set of candidate locations. In other words, the placement service may determine the set of candidate locations using a serialized pipeline in which each subsequent step in the pipeline relies on an output of a previous step in the pipeline. Based on the amount of filters and weights being applied, the serialized pipeline may take a variable amount of time to process the set of available deployment targets and output the set of candidate locations. Consequently, if a processing time limit is shorter than the processing time of the serialized pipeline, the placement service may be unable to apply each filter and weight within the processing time limit.

Additionally, the serialized pipeline may become slower to execute as more advanced filtering and weighting techniques are applied by the placement service. The use of hybrid computing environments can further complicate workload placement due to workloads spanning multiple platforms or locations that may each have particular attributes that affect management requirements. A processing time to determine a placement location can increase based on an amount of filters and weights being implemented in the serialized pipeline. In some cases, certain filters and weights may be applied at the same time to achieve a minor improvement in processing time. But the overall processing time of the serialized pipeline still depends on the number of filters and weights that need to be considered in a placement decision associated with the workload.

Some examples of the present disclosure can overcome one or more of the issues mentioned above by determining workload placement using plugin voting. The placement service can implement a voting system by requesting a vote or response from one or more plugins that can each make an individual decision to narrow down the set of candidate locations. Each plugin may make its individual decision based on a particular attribute of the candidate locations, resource requirements of the workload, or a combination thereof. Additionally, the placement service can indicate a time limit of receiving a respective response from the plugins, thereby setting a maximum processing time for a placement decision.

Once the time limit is exceeded, the placement service can determine the placement decision based on responses that the placement service has received. The attributes corresponding to any plugins that did not provide a response (e.g., cast a vote) within the time limit may not be considered by the placement service. By implementing plugin voting, the placement service can generate the placement decision within the time limit, preventing time variance with respect to assigning the workload to a suitable location. Additionally, by using plugin voting, the placement service may consider more attributes or apply more advanced filtering or weighting techniques compared to the serialized pipeline typically used to implement workload placement.

In one particular example, the placement service can transmit a respective message to each plugin in a computing environment to request that the plugins vote on a placement decision associated with a software application. The messages to the plugins can include a list of potential locations that the placement service has determined to be available in the computing environment to host the software application. From the list of potential locations, the plugins can each select a subset of the potential locations as one or more candidate locations to which to assign the software application. Each plugin can determine its candidate locations based on how a particular attribute of the potential locations may relate to resource requirements of the software application. For instance, a cloud environment may consume less power compared to a local node. After each plugin determines at least one candidate location, the plugins can generate a respective response including the candidate locations to respond to the messages transmitted by the placement service.

In addition to the list of potential locations, the messages sent by the placement service may include a time limit to restrict a response time of the plugins. If certain plugins of the computing environment fail to or are unable to provide a response within the time limit, the placement service may exclude these plugins from consideration with respect to the placement decision of the software application. By setting the time limit to respond with respect to the placement decision, the placement service can assign the software application to a suitable location in the computing environment within a predefined timeframe while accounting for multiple, and sometimes competing, attributes.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

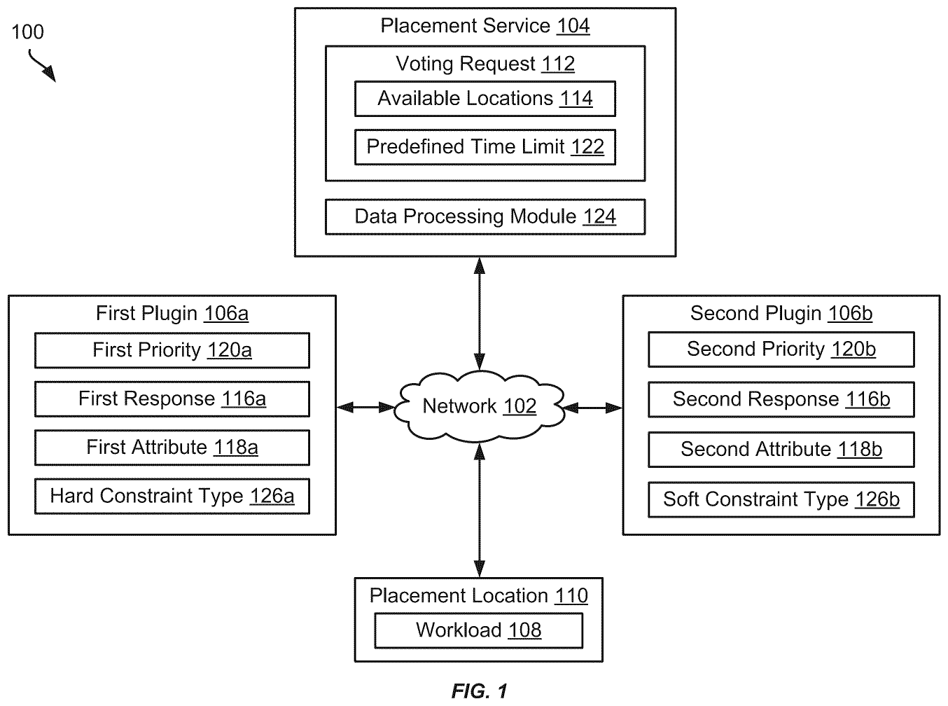

FIG. 1 is a block diagram of an example of a computing environment 100 for determining workload placement using plugin voting according to some examples of the present disclosure. The computing environment 100 may include on-premises computing systems, cloud-based computing systems, or a combination thereof. Components within the computing environment 100 may be communicatively coupled via a network 102, such as a local area network (LAN), wide area network (WAN), the Internet, or any combination thereof. For example, the computing environment 100 can include a placement service 104 and one or more plugins (e.g., a first plugin 106a and a second plugin 106b) that are communicatively coupled through the network 102. The plugins 106a-b can be software components that add a particular feature, such as an interaction interface, to an existing computer program (e.g., a host application). For example, the interaction interface can be an application programming interface (API). In some cases, the placement service 104 and the plugins 106a-b may be available on the same computing device. In other cases, the placement service 104 and the plugins 106a-b can be installed on different computing devices that are remote from each other, such as positioned at different physical locations. Examples of the computing devices can include desktop computers, laptop computers, servers, mobile phones, or tablets.

In some examples, the placement service 104 can be part of the computing environment 100 to generate a placement decision with respect to assigning a workload 108 to a suitable location in the computing environment 100 for execution. The placement service 104 can assign the workload 108 to a placement location 110 in the computing environment 100 based on one or more attributes that may be related to resource requirements of the workload 108, resource availability of candidate locations in the computing environment 100, or a combination thereof.

To make an informed placement decision that accounts for the attributes, the placement service 104 can transmit a voting request 112 to each plugin, such as to the first plugin 106a and to the second plugin 106b. As indicated above, the first plugin 106a and the second plugin 106b can be communicatively coupled to the placement service 104 via the network 102. Accordingly, the placement service 104 may transmit the voting request to the plugins 106a-b via the network 102, such as using the Internet or another suitable network. In some cases, the plugins 106a-b may be registered with the placement service 104 prior to the placement service 104 transmitting the voting request to the plugins 106a-b. For example, each plugin 106 may define a constructor that can be added to a registry associated with the placement service 104. Additionally, the computing environment 100 may include an integration bus or a message bus that can function as an intermediary between the placement service 104 and the plugins 106a-b. In some examples, the placement service 104 may transmit the voting request 112 as an event or a message to the integration bus or the message bus.

The voting request 112 can include a set of available locations 114 in the computing environment 100 to which the workload 108 can be assigned. The set of available locations 114 can be provided in the voting request 112 as a list or another suitable data structure. In some implementations, the voting request 112 may additionally include one or more resource requirements associated with the workload 108, such as storage requirements, processing power requirements, etc.

Based on the voting request 112, the plugins 106a-b can make a respective decision to narrow down the set of available locations to a respective subset of candidate locations. In some examples, the subset of candidate locations may include one candidate location. In other examples, the subset of candidate locations may include multiple candidate locations that are valid options that a particular plugin has determined based on certain attributes. Once the plugins 106a-b determine their respective subset of candidate locations, the plugins 106a-b can generate a respective response, such as a first response 116a and a second response 116b, to transmit to the placement service 104.

As an example, the first plugin 106a may apply a filter to the set of available locations 114 based on a first attribute 118a of anti-affinity rules that can indicate incompatibility between the workload 108 and one or more locations in the computing environment 100. More specifically, the anti-affinity rules may prevent the workload 108 from being assigned to a particular node in a computer network based on other services or applications on the particular node being known to interfere with the workload 108. Based on the anti-affinity rules, the first plugin 106a may exclude the particular node from its subset of candidate locations provided in the first response 116a to the placement service 104. In other words, the first plugin 106a can reduce the set of available locations 114 to include certain locations of the available locations that are compatible with the workload 108.

In some cases, the second plugin 106b may filter the set of available locations 114 based a second attribute 118b different from the first attribute 118a. For example, the second plugin 106b may determine its subset of candidate locations to provide in the second response 116b to the placement service 104 based on a latency requirement indicated in the voting request 112. The latency requirement may correspond to a maximum amount of latency associated with the workload 108. Based on the second attribute 118b corresponding to the latency requirement, the second plugin 106b can determine that local edge devices and datacenters are valid options for the placement location 110 whereas cloud environments may be excluded.

Other examples of the attributes 118a-b used by the plugins 106a-b to determine the candidate locations can include available computing resources at each available location, affinity rules, classification labels (e.g., label selectors, node selectors, taints, tolerations, etc.), availability zones, or a combination thereof. For instance, the plugins 106a-b can determine the candidate locations based on which available locations have sufficient resources (e.g., RAM, CPU, network bandwidth, network connectivity, etc.) to execute the workload 108. In some orchestration systems, such as Kubernetes, labels can be key/value pairs that can be attached to objects, such as with respect to the available locations, to specify identifying attributes of the objects. The label selectors can function as an identification or grouping mechanism by which one or more objects can be identified or filtered.

Similarly, the plugins 106a-b can narrow down the available locations 114 by using the node selectors to identify specific nodes or groups of nodes. For example, nodes (e.g., virtual or physical machines) may include labels specifying whether the nodes have certain isolation, security, or regulatory properties. As another example, the node labels may indicate whether each node has certain hardware or software resources, such as a solid-state drive attached to the node. Taints can function as a classification label indicating whether a particular node is incompatible with a set of pods (e.g., a group of one or more containers). Tolerations can be applied to a pod to schedule pods with matching taints.

An availability zone can correspond to a particular region associated with a cloud provider that provides a consistent set of features within the particular region. For example, the availability zone may include the same APIs and services. In some cases, the voting request 112 may indicate to the plugins 106a-b to determine the candidate locations such that the workload 108 can be assigned to a different availability zone than other workloads. By separating the workload 108 from the other workloads through placement of the workload 108 in the different availability zone, the placement service 104 can protect against a hardware failure or a planned maintenance event.

In some examples, the plugins 106a-b may be associated with a respective priority, such as a first priority 120a for the first plugin 106a and a second priority 120b for the second plugin 106b. The priorities 120a-b of the plugins 106a-b can affect how the placement service 104 determines the placement location 110. In some cases, the placement service 104 may determine the placement location 110 by counting the candidate locations provided in the responses 116a-b received from the plugins 106a-b. The placement service 104 can then select the placement location 110 from the candidate locations based on which candidate location has the most counts or occurrences in the responses 116a-b. A tie between two or more candidate locations may occur, such as if the first response 116a indicates a candidate location that is different from another candidate location indicated in the second response 116b. Consequently, the placement service 104 can select the candidate location indicated in the first response 116a as the placement location 110 based on the first priority 120a associated with the first response 116a. For example, the placement service 104 may count the first response 116a of the first plugin 106a twice based on the first plugin 106a having a higher priority than the second plugin 106b. In some examples, the placement service 104 may identify the priorities 120a-b of the plugins 106a-b using the responses 116a-b generated by the plugins 106a-b.

Although two plugins are depicted in FIG. 1, it will be appreciated that the computing environment 100 may include more than two plugins, such as tens or hundreds of plugins, that can provide a respective response to the placement service 104. In some cases, two or more plugins may determine a respective subset of candidate locations based on the same attribute. In such cases, the plugins that are using the same attribute to narrow down the set of available locations may include different locations in their respective responses to the placement location 110.

In some examples, the voting request 112 additionally can include a predefined time limit 122 associated with the placement decision of the workload 108. In particular, the placement service 104 may proceed to determine the placement decision once the predefined time limit 122 has been exceeded. Accordingly, the predefined time limit 122 can function as an upper limit to restrict processing time used to determine the placement location 110 of the workload 108. The placement service 104 can ignore any responses that are received after the predefined time limit 122 is exceeded. In some examples, this functionality can be referred to as a “lazy” mechanism in which the plugins 106a-b of the computing environment 100 participate in decision-making of the placement location 110 if a corresponding vote is casted within the predefined time limit 122.

In some examples, the placement service 104 may include a data processing module 124, such as to perform dimensionality reduction. Dimensionality reduction can refer to a process of decreasing a number of features associated with the set of candidate locations while minimizing information loss to preserve data of interest. In other words, dimensionality reduction can convert data associated with the set of candidate locations from a high-dimensional space to a lower-dimensional space while maintaining significant characteristics of the data. The placement service 104 can apply dimensionality reduction to the set of candidate locations to generate a reduced dataset that is less complex compared to the data associated with the set of candidate locations. The lower complexity of the reduced dataset can facilitate data processing, data visualization, or other forms of data analysis and may conserve processing time to determine the placement location 110 of the workload 108. Non-limiting methods to apply dimensionality reduction include principal component analysis (PCA), singular value decomposition (SVD), or linear discriminant analysis (LDA).

The data processing module 124 of the placement service 104 can determine which features of the set of candidate locations to remove based on a respective constraint type 126 of the plugins 106a-b. For example, as depicted in FIG. 1, the first plugin 106a is associated with a first constraint type (e.g., a hard constraint type 126a) while the second plugin 106b is associated with a second constraint type (e.g., a soft constraint type 126b). Based on the first plugin 106a being associated with the hard constraint type 126a, the first response 116a of the first plugin 106a may be preserved during dimensionality analysis such that the first response 116a is accounted for in the placement decision. On the other hand, the soft constraint type 126b of the second plugin 106b can cause the data processing module 124 to remove the second response 116b generated by the second plugin 106b from consideration in the placement decision. In other words, the soft constraint type 126b can indicate that the second response 116b has lower pertinence to determining the placement location 110 compared to the first response 116a.

As an example, if the workload 108 is associated with edge computing, the hard constraint type 126a of the first plugin 106a may correspond to a first attribute 118a of computing infrastructure at the available locations 114 being considered. The soft constraint type 126b of the second plugin 106b can correspond to a second attribute 118b related to carbon emissions or green computing. If the placement service 104 has sufficient resources (e.g., memory, processing power, processing time, etc.), the placement service 104 may consider both attributes 118a-b when determining the placement location 110. Conversely, the placement service 104 may have difficulty considering each response 116 of the plugins 106a-b, particularly in cases in which the placement service 104 receives tens or hundreds of responses from plugins in the computing environment 100. Accordingly, the placement service 104 may execute the data processing module 124 to perform dimensionality reduction, thereby removing the second response 116b from consideration.

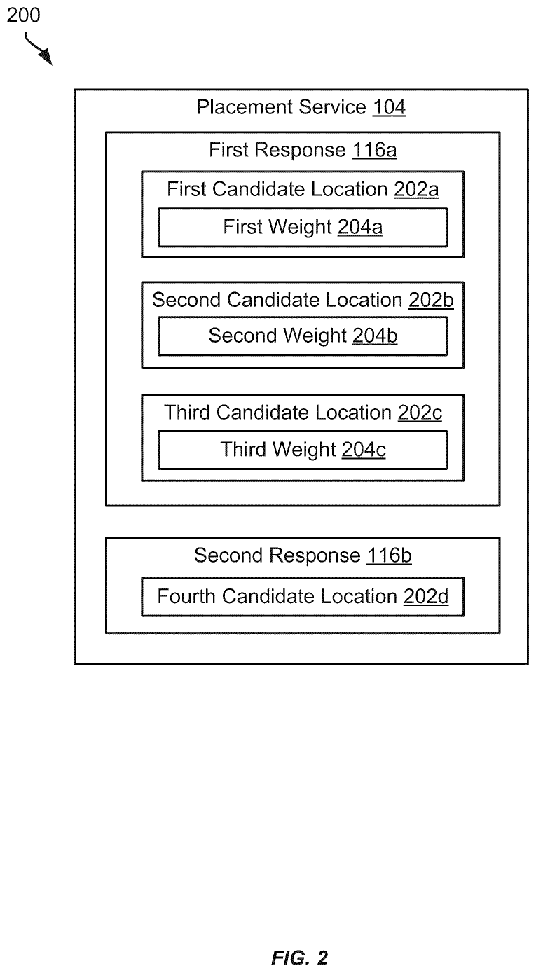

FIG. 2 is a block diagram 200 of responses 116a-b received by a placement service 104 to determine a workload placement using plugin voting according to some examples of the present disclosure. In some examples, the placement service 104 depicted in FIG. 2 can correspond to the placement service 104 described above with respect to FIG. 1. Components of FIG. 2 are described below with reference to aspects of FIG. 1.

As described herein, the placement service 104 can receive the responses 116a-b in response to a voting request 112 transmitted by the placement service 104 to one or more plugins 106a-b. As depicted in FIG. 2, a first response 116a indicates three candidate locations 202a-c, such as a first candidate location 202a, a second candidate location 202b, and a third candidate location 202c. A second response 116b indicates a single candidate location (e.g., a fourth candidate location 202d). In some examples, the responses 116a-b may include different numbers of candidate locations 202 in a respective subset of the candidate locations 202 determined by a corresponding plugin, such as the first plugin 106a and the second plugins 106b of FIG. 1. In other examples, the responses 116a-b can include the same number of candidate locations 202, such as the first response 116a and the second response 116b both indicating one candidate location.

In some examples, the responses 116a-b may rank each candidate location 202 by including a respective weight corresponding to each candidate location 202 of the respective subset of the candidate locations 202 provided in each response 116. For example, the first response 116a can include a first weight 204a corresponding to the first candidate location 202a, a second weight 204b corresponding to the second candidate location 202b, and a third weight 204c corresponding to the third candidate location 202c. As described herein, the weights 204a-c can indicate a relative priority of a corresponding candidate location. In some cases, the first weight 204a may indicate a greater priority compared to the second weight 204b and the third weight 204c. For instance, the first weight 204a may be the highest weight of the three weighs 204a-c, thereby corresponding to the highest priority.

As an example, the first candidate location 202a, the second candidate location 202b, and the third candidate location 202c may be determined by the first plugin 106a after filtering to be suitable locations to assign the workload 108. In particular, after filtering a set of available locations 114 to determine the candidate locations 202a-c, the first plugin 106a can use a weighting system to determine a respective weight 204 of the candidate locations 202a-c. After applying the weighting system, the first plugin 106a may assign a first weight 204a of 80 to the first candidate location 202a, a second weight 204b of 52 to the second candidate location 202b, and a third weight 204c of 45 to the third candidate location 202c.

In some implementations, the weights 204a-c indicated in the first response 116a may depend on priorities associated with certain attributes (e.g., the first attribute 118a and second attribute 118b of FIG. 1). Additionally or alternatively, other attributes that may affect the weights 204a-c of the candidate location 202a-c can include a consumption of certain resource types, cost, carbon emissions, etc. Examples of the resource types may include network bandwidth, electrical power, virtual memory, disk drives, cache space, etc. Based on the weights 204a-c, the placement service 104 can determine which of the candidate locations 202a-c to select. In some examples, the placement service 104 may consider the weights 204a-c of the candidate locations 202a-c in conjunction with a corresponding priority (e.g., the first priority 120a of FIG. 1) associated with the first response 116a.

In some examples, if a particular response includes a single candidate location, the particular response may omit a corresponding weight of the candidate location. For example, as depicted in FIG. 2, the second response 116b includes the fourth candidate location 202d as the only candidate location in the second response 116b. Accordingly, providing a corresponding weight for the fourth candidate location 202d in the second response 116b may be unnecessary.

While FIGS. 1-2 depict a specific arrangement of components, other examples can include more components, fewer components, different components, or a different arrangement of the components shown in FIGS. 1-2. For instance, in other examples, the computing environment 100 may include cloud computing systems and local computing devices to represent the available locations 114 to which the workload 108 can be assigned. Additionally, any component or combination of components depicted in FIGS. 1-2 can be used to implement the process(es) described herein.

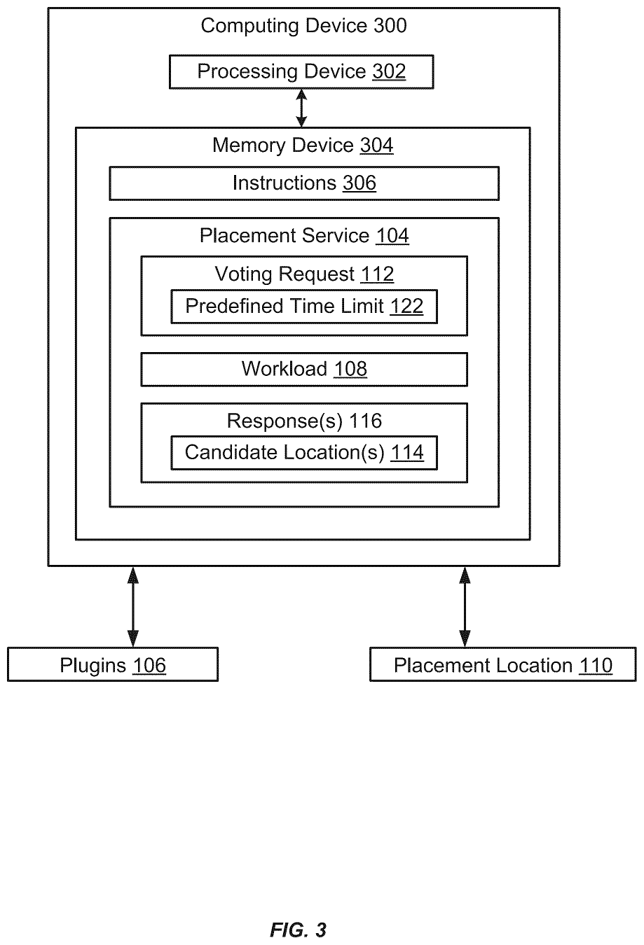

FIG. 3 is a block diagram of an example of a computing device 300 for determining workload placement using plugin voting according to some examples of the present disclosure. The computing device 300 can include a processing device 302 communicatively coupled to a memory device 304. Certain aspects of FIG. 3 are described below with reference to components of FIG. 1.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C#, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can transmit a voting request 112 to one or more plugins 106 to determine a placement location 110 at which to assign a workload 108. The placement location 110 can be a computing device or computing system that can provide access to suitable resources or infrastructure to fulfill resource requirements associated with executing the workload 108. In some examples, the voting request 112 transmitted by the processing device 302 may include the resource requirements such that the plugins 106 can vote on the placement location 110 based on the resource requirements. Additionally or alternatively, the voting request 112 can indicate a predefined time limit 122 by which to respond to the voting request 112. Any responses from the plugins 106 received by the processing device 302 after the predefined time limit has passed may be excluded from consideration by the processing device 302 when determining the placement location 110.

Based on responses 116 received from the plugins 106 within the predefined time limit 122, the processing device 302 can select the placement location 110 from a set of candidate locations 202 indicated in the responses 116. After determining the placement location 110, the processing device 302 can assign the workload 108 to the placement location 110 to be executed at the placement location 110. In general, the workload 108 can be a service, application, or capability that consumes computing resources. Non-limiting examples of the workload 108 can include virtual machines, databases, applications, microservices, or nodes.

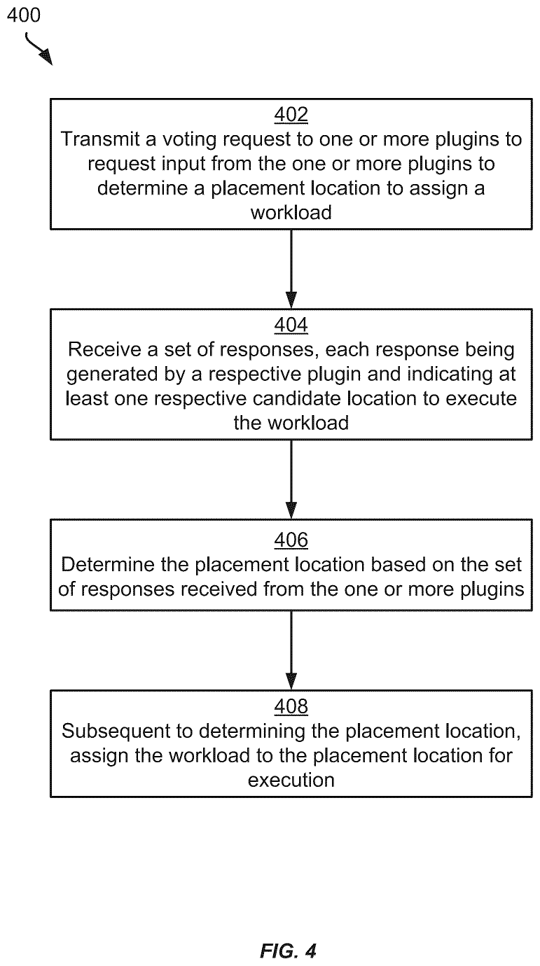

FIG. 4 is a flowchart of a process 400 for determining workload placement using plugin voting according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 transmits, by a placement service 104, a voting request 112 to one or more plugins 106a-b to request input from the one or more plugins 106a-b to determine a placement location 110 to assign a workload 108. The voting request 112 can indicate a predefined time limit 122 by which to respond to the voting request 112. For instance, the predefined time limit 122 may indicate that the placement service 104 will execute a data processing module 124 after one second to begin determining the placement location 110. In other words, the predefined time limit 122 can define an upper limit of a response time of each plugin 106 to generate and transmit a respective response to the placement service 104.

In block 404, the processing device 302 receives, by the placement service 104, a set of responses 116a-b. Each response can be generated by a respective plugin and can indicate at least one respective candidate location to execute the workload 108. For example, a first response 116a generated by a first plugin 106a can indicate a first set of candidate locations 202a-c determined by the first plugin 106a based on a first attribute 118a of a set of available locations 114. The processing device 302 can provide the set of available locations 114 to the plugins 106a-b as part of the voting request 112. A second response 116b generated by a second plugin 106b can include a second set of candidate locations 202d different from the first set of candidate locations 202a-c due to being determined by a second plugin 106b based on a second attribute 118b.

As an example, the first response 116a may be generated by the first plugin 106a based on a first attribute 118a related to a respective availability of computing resources at each available location to support a performance of the workload 108. In contrast, the second response 116b can be generated by the second plugin 106b based on a second attribute 118b related to compliance of the workload 108, such as with respect to information security or privacy guidelines. Based on the different attributes used to determine the responses 116a-b, the respective set of candidate locations 202 indicated in each response may differ.

In block 406, the processing device 302 can determine, by the placement service 104, the placement location 110 based on the set of responses 116a-b received from the one or more plugins 106a-b. The responses 116a-b can each provide a respective set of candidate locations 202 to the processing device 302 to enable the processing device 302 to select the placement location 110 from an aggregated set of candidate locations 202. The aggregated set of candidate locations 202 can include the first set of candidate locations 202a-c indicated in the first response 116a and the second set of candidate locations 202d indicated in the second response 116b. In some examples, the processing device 302 may use the placement service 104 to select the placement location 110 based on a respective weight 204 of the candidate locations 202a-d, a respective priority 120 of the plugins 106a-b, or a combination thereof. As an example, a particular candidate location with a relatively high weight may be passed over or ignored by the processing device 302 in favor of a different candidate location with a lower weight but provided by a particular plugin with a relatively high priority.

In block 408, subsequent to determining the placement location 110, the processing device 302 can assign, by the placement service 104, the workload 108 to the placement location 110 for execution. Non-limiting types of the workload 108 include transactional workloads, batch workloads, analytical workloads, database workloads, or high-performance computing workloads. In some examples, executing the workload 108 may involve running a software application, performing a computation, processing data analytics, or running a suite of interconnected applications. Once assigned to the placement location 110, the workload 108 can be executed using computing resources (e.g., network connectivity, memory access, computational power, etc.) provided at the placement location 110. In some examples, the placement location 110 of the workload 108 may be adjusted at a later point, such as due to infrastructural changes related to system performance, user traffic, resource allocation, processing needs, or a combination thereof. In examples in which the workload 108 is reassigned to another placement location, blocks 402 through 408 may be repeated.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
transmitting, by a placement service, a voting request to one or more plugins to request input from the one or more plugins to determine a placement location to assign a workload, the voting request indicating a predefined time limit by which to respond to the voting request;
receiving, by the placement service, a set of responses, each response being generated by a respective plugin and indicating at least one respective candidate location to execute the workload;
determining, by the placement service, the placement location based on the set of responses received from the one or more plugins; and
subsequent to determining the placement location, assigning, by the placement service, the workload to the placement location for execution.

2. The system of claim 1, wherein determining the placement location comprises: selecting, by the placement service, the placement location from a set of candidate locations comprising the at least one respective candidate location of each response received by the placement service prior to the predefined time limit being exceeded.

3. The system of claim 1, wherein the voting request indicates a set of available locations, and wherein each plugin is configured to select a respective subset of the available locations to indicate as the at least one respective candidate location in a respective response.

4. The system of claim 3, wherein each plugin is configured to select the respective subset of the available locations by filtering the set of available locations based on one or more attributes of the available locations.

5. The system of claim 3, wherein the respective response indicates a ranking of the subset of the available locations selected by the plugin to indicate a respective weight of each available location in the subset of the available locations.

6. The system of claim 1, wherein each response received by the placement service indicates a respective priority of a corresponding plugin, and wherein determining the placement location further comprises:
determining, by the placement service based on each response received, the respective priority of the corresponding plugin that has responded to the voting request by the predefined time limit; and
selecting the placement location from the at least one respective candidate location indicated in the set of responses based on the respective priority of each plugin that has responded to the voting request by the predefined time limit.

7. The system of claim 1, wherein determining the placement location comprises, subsequent to the predefined time limit being exceeded:
identifying a subset of the responses based on a respective constraint type corresponding to each plugin that responded to the voting request; and
applying dimensionality reduction to the subset of the responses received by the placement service.

8. A method comprising:
transmitting, by a placement service, a voting request to one or more plugins to request input from the one or more plugins to determine a placement location to assign a workload, the voting request indicating a predefined time limit by which to respond to the voting request;
receiving, by the placement service, a set of responses, each response being generated by a respective plugin and indicating at least one respective candidate location to execute the workload;
determining, by the placement service, the placement location based on the set of responses received from the one or more plugins; and
subsequent to determining the placement location, assigning, by the placement service, the workload to the placement location for execution.

9. The method of claim 8, wherein determining the placement location comprises:
selecting, by the placement service, the placement location from a set of candidate locations comprising the at least one respective candidate location of each response received by the placement service prior to the predefined time limit being exceeded.

10. The method of claim 8, wherein the voting request indicates a set of available locations, and wherein each plugin is configured to select a respective subset of the available locations to indicate as the at least one respective candidate location in a respective response.

11. The method of claim 10, wherein each plugin is configured to select the respective subset of the available locations by filtering the set of available locations based on one or more attributes of the available locations.

12. The method of claim 10, wherein the respective response indicates a ranking of the subset of the available locations selected by the plugin to indicate a respective weight of each available location in the subset of the available locations.

13. The method of claim 8, wherein each response received by the placement service indicates a respective priority of a corresponding plugin, and wherein determining the placement location further comprises:
determining, by the placement service based on each response received, the respective priority of the corresponding plugin that has responded to the voting request by the predefined time limit; and
selecting the placement location from the at least one respective candidate location indicated in the set of responses based on the respective priority of each plugin that has responded to the voting request by the predefined time limit.

14. The method of claim 8, wherein determining the placement location comprises, subsequent to the predefined time limit being exceeded:
identifying a subset of the responses based on a respective constraint type corresponding to each plugin that responded to the voting request; and
applying dimensionality reduction to the subset of the responses received by the placement service.

15. A non-transitory computer-readable medium comprising program code executable by a processing device for causing the processing device to perform operations comprising:
transmitting, by a placement service, a voting request to one or more plugins to request input from the one or more plugins to determine a placement location to assign a workload, the voting request indicating a predefined time limit by which to respond to the voting request;
receiving, by the placement service, a set of responses, each response being generated by a respective plugin and indicating at least one respective candidate location to execute the workload;
determining, by the placement service, the placement location based on the set of responses received from the one or more plugins; and
subsequent to determining the placement location, assigning, by the placement service, the workload to the placement location for execution.

16. The non-transitory computer-readable medium of claim 15, wherein determining the placement location comprises:
selecting, by the placement service, the placement location from a set of candidate locations comprising the at least one respective candidate location of each response received by the placement service prior to the predefined time limit being exceeded.

17. The non-transitory computer-readable medium of claim 15, wherein the voting request indicates a set of available locations, and wherein each plugin is configured to select a respective subset of the available locations to indicate as the at least one respective candidate location in a respective response.

18. The non-transitory computer-readable medium of claim 17, wherein each plugin is configured to select the respective subset of the available locations by filtering the set of available locations based on one or more attributes of the available locations.

19. The non-transitory computer-readable medium of claim 17, wherein the respective response indicates a ranking of the subset of the available locations selected by the plugin to indicate a respective weight of each available location in the subset of the available locations.

20. The non-transitory computer-readable medium of claim 15, wherein each response received by the placement service indicates a respective priority of a corresponding plugin, and wherein determining the placement location further comprises:
determining, by the placement service based on each response received, the respective priority of the corresponding plugin that has responded to the voting request by the predefined time limit; and
selecting the placement location from the at least one respective candidate location indicated in the set of responses based on the respective priority of each plugin that has responded to the voting request by the predefined time limit.
